(19) United States
(12) Patent Application Publication
(10) Pub. No.: US 2009/0022024 A1
(43) Pub. Date: Jan. 22, 2009

(54) METHOD AND APPARATUS FOR DETECTING OPTICAL DISK STATE

(75) Inventor: Yasuhiro Hayashi, Yokohama-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/173,423

(22) Filed: Jul. 15, 2008

(30) Foreign Application Priority Data
Jul. 19, 2007 (JP) 2007-187901

(51) Int. Cl. G11B 5/58

(52) U.S. Cl. 369/53.17

(57) ABSTRACT

This disclosure concerns an optical disk state detection apparatus comprising a defect detector to which a signal read from an optical disk is imparted, the defect detector detecting a defect to supply a defect detection signal; rotation synchronous pulse generator supplying a rotation synchronous pulse in synchronization with rotation of the optical disk; a memory in which the defect detection signal is stored, the defect detection signal being imparted to the memory; a write circuit performing write processing of data to the memory; a read circuit performing read processing of data from the memory; and a system controller which controls the read circuit such that the defect detection signal is written in the memory in synchronization with the rotation synchronous pulse and such that the defect detection signal is read at least one time every one rotation of the optical disk from the memory in synchronization with the rotation synchronous pulse.

### CROSS-REFERENCE TO RELATED APPLICATION

This application is based upon and claims the benefit of priority from the prior Japanese Patent Application No. 2007-187901, filed on Jul. 19, 2007, the entire contents of which are incorporated herein by reference.

### BACKGROUND OF THE INVENTION

1. Field of the Invention

The present invention relates to a method and an apparatus for detecting an optical disk state.

2. Related Art

Recently, standardization is made to provide usability equal to a removable medium such as a floppy disk and an MO disk to CD-RW and DVD+RW, and a standard called Mt. Rainier is proposed.

The Mt. Rainier standard is also called “CD-MRW and DVD+MRW”, and plural companies promote the Mt. Rainier standard as a core member.

In order to write data on a disk from Explorer on Windows by drug and drop like the MO disk and floppy disk, usually it is necessary to utilize packet writing software which supports packet write.

However, because OS (Operating System) such as Windows does not support the Mt. Rainier standard as standard, not only the packet writing software is required in write, but also dedicated reader software is required in read.

When a commercially available medium is utilized in the packet writing software, because disk formatting work is previously required, the writing work is not immediately started. Therefore, the Mt. Rainier standard exists to solve the problem.

The Mt. Rainier standard is intended to unify defect (defective sector) management and the like by the hardware (drive) to realize standard support of OS.

In the conventional packet write, the packet writing software manages the defective sector, and the packet writing software writes 2K-bite data delivered from OS in a 64K-bite fixed-length packet. In the Mt. Rainier standard, such pieces of processing are transferred onto the hardware side to facilitate the support of OS.

Additionally, the medium formatting work is performed in on-demand background processing by the hardware, so that a user can immediately start the write of data only by inserting a purchased medium into the drive.

However, there is the following problem in the conventional defect, that is, defective sector management performed by the hardware drive.

When a defect area is detected, a sector portion of the defect area is swapped for a replacement area set in an outer circumferential region of a disk, thereby writing the data in a normal area. However, because a definition of the defect depends on each drive, there are various detection and judgment techniques.

Particularly, in the case of a high-speed drive, it takes a long time to make the detection, which possibly leads to a decrease in drive write performance. As the number of types of the disk is increased, there is also a problem in that the stable detection of the defect is hardly performed.

### SUMMARY OF THE INVENTION

An optical disk state detection apparatus according to an embodiment of the present invention comprises a defect detector to which a signal read from an optical disk is imparted, the defect detector detecting a defect to supply a defect detection signal; rotation synchronous pulse generator supplying a rotation synchronous pulse in synchronization with rotation of the optical disk; a memory in which the defect detection signal is stored, the defect detection signal being imparted to the memory; a write circuit which performs write processing of data to the memory; a read circuit which performs read processing of data from the memory; and a system controller which controls the read circuit such that the defect detection signal is written in the memory in synchronization with the rotation synchronous pulse and such that the defect detection signal is read one time every one rotation of the optical disk from the memory in synchronization with the rotation synchronous pulse.

A method for detecting an optical disk state in an optical disk apparatus according to an embodiment of the present invention, the optical disk apparatus including rotation synchronous pulse generator, a system controller, a defect detector, a write circuit, a read circuit, and a memory, the method comprises detecting a defect from a signal read from an optical disk by the defect detector and supplying a defect detection signal; controlling the write circuit by the system controller such that the defect detection signal is written in the memory in synchronization with a rotation synchronous pulse, the rotation synchronous pulse being generated from the rotation synchronous pulse generator in synchronization with rotation of the optical disk; and controlling the read circuit by the system controller such that the defect detection signal written in the memory is read one time every one rotation of the optical disk in synchronization with the rotation synchronous pulse.

### BRIEF DESCRIPTION OF THE DRAWINGS

FIG. 1 is a block diagram showing a configuration of an apparatus for detecting an optical disk state according to the first embodiment of the present invention;

FIG. 2 is a flowchart showing procedure in the optical disk state detection method executed by the optical disk state detection apparatus;

FIG. 3 shows a data area, replacement area and a guard area in the optical disk;

FIG. 4 is a time chart showing a vibration of waveforms of the signals during detecting a shock;

FIG. 5 is a time chart showing a vibration of waveforms of the signals during detecting a defect;

FIG. 6 is a time chart showing waveforms of the signals during the memory operation;

FIG. 7 is a time chart showing waveforms of the signals during reading out data from the memory; and

FIG. 8 is a block diagram showing a configuration of the memory.

### DETAILED DESCRIPTION OF THE INVENTION

A method and an apparatus for detecting an optical disk state according to an embodiment of the invention will be described below with reference to the drawings. In the embodiment, a servo control system is formed by a digital circuit.

An optical pickup 12 reads a signal from an optical disk 11, and an RF (Radio Frequency) amplifier 15 takes out a servo system error signal and an information data signal RF.

An AD converter 16a converts a tracking error signal TE which is of the servo system error signal into a digital signal, and the digital tracking error signal is fed into a tracking servo control circuit 16. Then, a tracking actuator, a focus actuator, and a feed motor 14 which operates the whole of the optical pickup 12 are driven using the digital tracking error signal through a feed motor control circuit 17, a DA converter 18a, and an amplifier 18 such that the optical pickup 12 can follow a spiral track.

An adder 41 adds a control signal supplied from the tracking servo control circuit 16 to a driving signal supplied from a lens driving signal generation circuit 22a, and the added signal is imparted to the optical pickup 12 through a DA converter 20a and an amplifier 20.

An AD converter 19a converts a focus error signal FE which is of the servo system error signal into a digital focus error signal, and the digital focus error signal is fed into a defocus/detrack detection circuit 32 and a focus servo control circuit 19.

The defocus/detrack detection circuit 32 detects a focus error and a servo abnormal state, and the results are imparted to and stored in a memory 33. The focus error is caused by a molding defect or a vibration of the optical disk 11, and the servo abnormal state is caused by a tracking error.

The focus servo control circuit 19 produces and supplies the control signal such that a light beam focuses on the optical disk 11, and an adder 42 adds the control signal to a driving signal supplied from a lens driving signal generation circuit 22. Then, the added signal is imparted to the optical pickup 12 through a DA converter 21a and an amplifier 21.

In a reproduction system, the information data signal RF is fed into a data extraction circuit/synchronous demodulation circuit and CD/DVD data correction processing circuit/parity production circuit 26 (hereinafter, circuit 26), and the information data signal RF is binarized by data extraction processing. Then, bit clock extraction processing, synchronous signal extraction processing, and demodulation processing are performed to the information data signal RF.

Using a correction RAM 27, the circuit 26 performs correction processing to the data, to which the demodulation processing is already performed, and to the synchronous clock.

In the case of disk rotation control at Constant Lines Velocity (CLV), the circuit 26 produces a reproduction synchronous signal, and the reproduction synchronous signal is supplied to a disk motor control circuit 23 to control a disk motor 13 through a disk motor driver 24.

Usually, in a high-speed reproduction drive, Constant Angular Velocity (CAV) control is frequently used. In such cases, the disk motor 13 produces a clock signal FG synchronized with the number of rotations of the motor, the disk motor 13 feeds the clock signal FG into the disk motor control circuit 23, and the disk motor 13 is controlled through a buffer 24 such that the clock signal FG is kept at a constant period.

The RF amplifier 15 supplies a wobble signal to a wobble PLL and decoder 26b, the wobble PLL and decoder 26b supplies address information indicating a position of the optical pickup 12 on the optical disk 11 to a system controller 25, and the system controller 25 supplies a control signal on the basis of the address information.

The circuit 26 also supplies a clock produced based on reproduction data to the disk motor control circuit 23.

Thus, the signals of three control systems, that is, the clock signal FG supplied from the disk motor 13, the control signal supplied from the system controller 25, and the clock supplied from the circuit 26 are fed into the disk motor control circuit 23.

On the other hand, the circuit 26 is fed into a data buffer circuit 28, and buffering is performed in the data buffer circuit 28. Then, the data is transferred to a host computer through a host I/F (not shown).

In the case where data is recorded, the host computer supplies the data to the data buffer circuit 28 through the host I/F. The data buffer circuit 28 tentatively writes the data in a memory of the data buffer circuit 28, and the data buffer circuit 28 sequentially transfers the data to the circuit 26.

In the circuit 26, a correction RAM 27 is used to add parity data to the transferred data.

The data to which the parity data is added is modulated into bit stream data recorded in the optical disk 11, the data is transmitted to a laser power modulation circuit 29, and recording laser of the optical pickup 12 is modulated to form a pit. A recording control including a control of a recording start timing is performed according to a physical address and recording timing. The wobble PLL and decoder 26b produces the physical address and recording timing on the basis of a wobble signal produced by the RF amplifier 15.

An average wave detector 30 detects a DC component included in the information data signal RF produced by the RF amplifier 15, and the average wave detector 30 transmits the DC component to a defect detection circuit 31. The defect detection circuit 31 detects the defect to produce a defect detection signal, and the defect detection circuit 31 writes the defect detection signal in a memory 33.

Thus, the defect detection signal supplied from the defocus/detrack detection circuit 32 and the defect detection signal supplied from the defect detection circuit 31 are fed into and written in the memory 33.

A write address circuit 34 writes the signals in the memory 33 in synchronization with a pulsed clock signal FG supplied from the disk motor 13, and the pulsed clock signal FG is synchronized with rotation of the disk motor 13. The write address circuit 34 supplies an interrupt signal to the system controller 25, and the interrupt signal is generated one time every one rotation of the optical disk 11. The interrupt signal is fed into the system controller 25 in the form of a one-rotation interrupt signal.

The read circuit 35 reads the data stored in the memory 33 according to the address specified by the read address circuit 34a, the read circuit 35 supplies the data to system controller 25, and the system controller 25 detects whether or not the defect is generated. The read circuit 35 reads the data per one rotation of the optical disk 11 at high speed in synchronization with the interrupt signal.

The system controller 25 has a function of controlling an operational sequence of each circuit. The system controller 25 always monitors the defect. In the case where the system controller 25 detects the defect, the system controller 25 registers a defect position on the optical disk 11 in a defect table of a data area, and the system controller 25 performs processing for writing the data, which should be written in the defect position, in a replacement area.

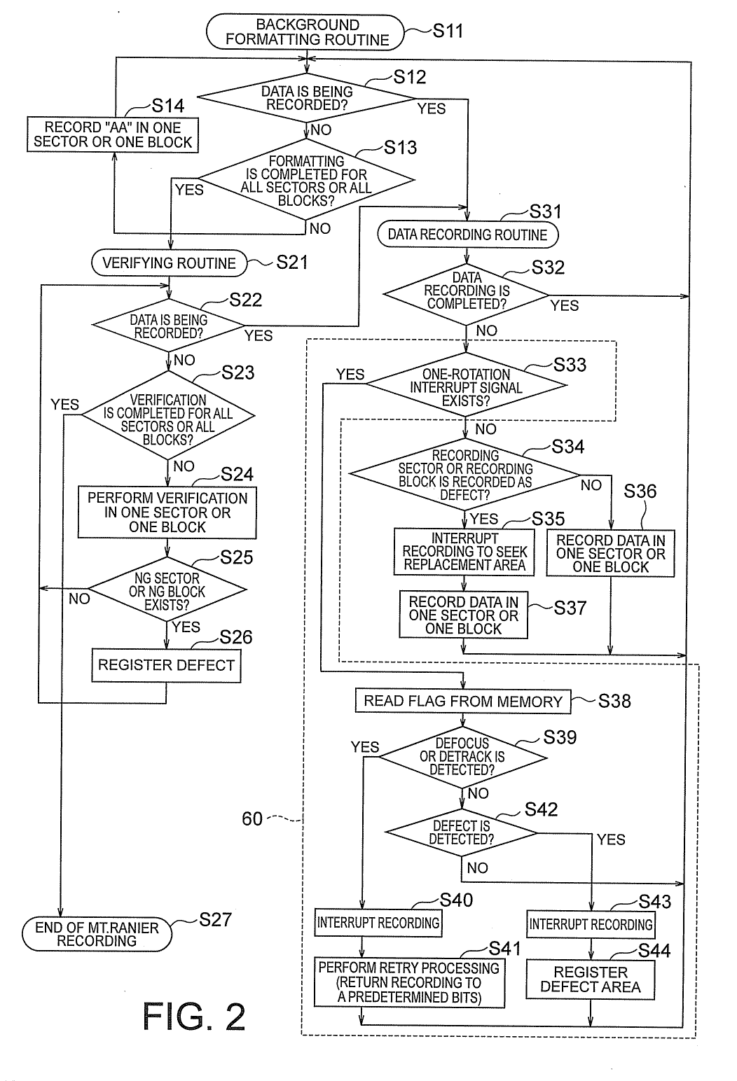

A defect detection processing procedure in the optical disk state detection method in which the optical disk state detection apparatus of the embodiment is used will be described with reference to a flowchart of FIG. 2.

As described above, the Mt. Rainier recording provides the medium system, in which OS mounted on personal computer supports the optical disk recording to write the data immediately after the optical disk is inserted into the drive.

In order to realize the function, it is necessary to perform the formatting processing in the background, and it is necessary to perform the defect management. In the defect management, the recording defective portion such as the defect existing in a data recording area is swapped for a replacement area of the outer circumferential portion of the optical disk, and the data is recorded in the replacement area.

Obviously it is assumed that the optical disk is the rewritable system. For example, there has been proposed a standard in which the Mt. Rainier recording is supported in CD-RW and DVD+RW. In the Mt. Rainier recording, the formatting is performed in the background, the processing is performed in one sector unit (2K bytes) in CD, and the processing is performed in one block unit (16 sectors) in DVD.

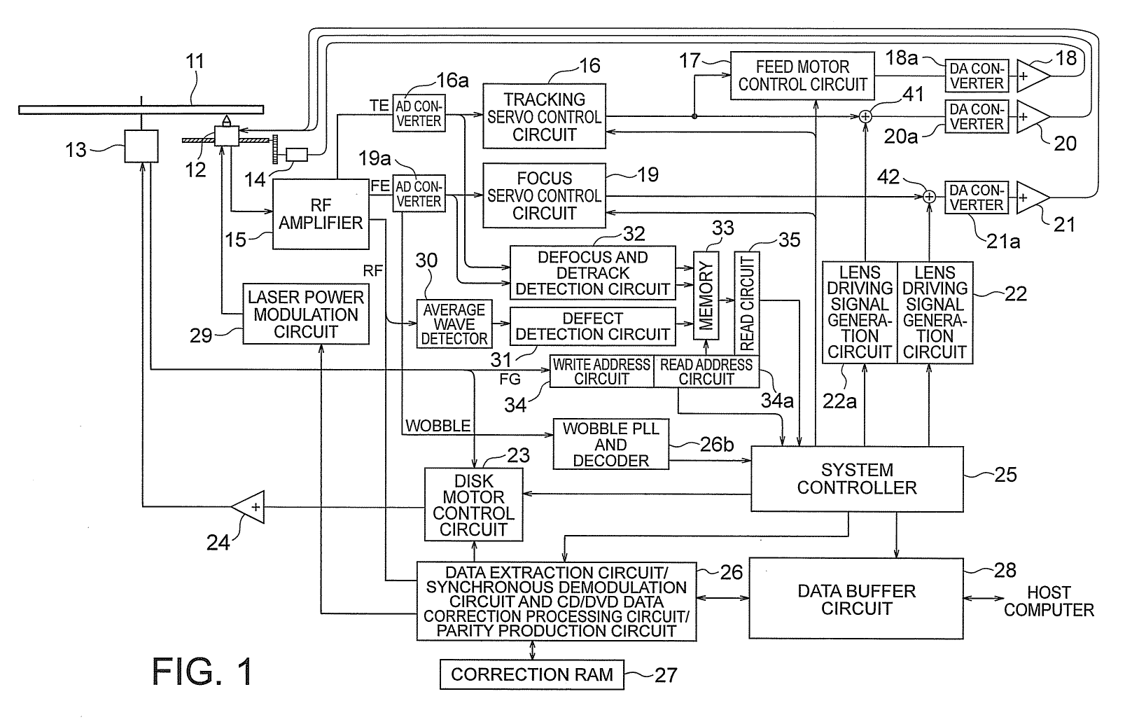

The system controller 25 of FIG. 1 performs the following processing. A background formatting routine is started in Step S11.

In Step S14, the formatting processing is performed by recording verifying data of, for example, “AA” over the surface of the optical disk in one sector unit or one block unit. In Steps S12, S13, and S14, the formatting is performed to all the sectors or all the blocks. In Step S12, when the system controller 25 determines that the data which should originally be recorded unlike the verifying data is being recorded, the flow goes to Step S31.

After the formatting is completed, a verify routine is started in Step S21. In the verifying routine, the read is performed from an inner circumference of the optical disk 11 toward an outer circumference to check whether or not the recorded data “AA” is correctly read.

In Step S22, the system controller 25 determines whether or not the data is being recorded. When the data is being recorded, the flow goes to a data recording routine in Step S31. When the data is not being recorded, the flow goes to Step S24 through Step S23.

In Step S24, the system controller 25 performs the verification in one sector or one block. In Step S25, the system controller 25 determines whether or not a defective (NG) sector or a defective (NG) block exists. When the defective sector or defective block exists, the system controller 25 registers the defect in Step S26.

The verifying processing is performed by the loop from Step S22 to Step S26 until the verification is completed to all the sectors or all the blocks. The verifying routine is ended when the verification is completed, and the Mt. Rainier recording is ended in Step S27.

In the verifying routine in Steps S21 to S26, the result has high reliability because the verification is made by actually writing and reading the data “AA”.

When the system controller 25 determines that the data is being recorded in Steps S12 and S22, the flow goes to a data recording routine in Step S31.

The flow goes to Step S33 through Step S32. In Step S33, the system controller 25 determines whether or not a one-rotation interrupt signal is fed. As described below, two types of memory banks A and B are included in the memory, and the memory banks A and B are changed every one rotation of the optical disk 11 to read the data. The flow goes to Step S38 when the one-rotation interrupt signal is fed, and the flow goes to Step S34 when the one-rotation interrupt signal is not fed.

In Step S34, the system controller 25 determines whether or not the recording sector or recording block is registered as the defect. When the recording sector or recording block is registered as the defect, the recording is interrupted to seek the replacement area in Step S35, and the data is recorded in one sector or one block in Step S37. When the recording sector or recording block is not registered as the defect, the data is recorded in one sector or one block in Step S36. The flow returns to Step S12 after Step S36 or S37.

When the system controller 25 determines that the one-rotation interrupt signal is fed in Step S33, a flag is read from one of the memory banks A and B of the memory 33 in Step S38.

In Step S39, the system controller 25 determines whether or not the defocus or detrack is detected. When the defocus or detrack is detected, the data recording is interrupted in Step S40, and the flow goes to Step S41. Because the defocus or detrack is a temporary phenomenon caused by a shock unlike the defect, frequently the data can be written and read again. Therefore, the write processing (retry) is performed again by returning to predetermined bits in Step S41, and the flow returns to Step S12.

When the defocus or detrack is not detected in Step S39, the system controller 25 determines whether or not the defect is detected in Step S42. When the defect is detected, the data recording is interrupted in Step S43, and the defect position is registered in the defect table of the data area in Step S44. When the defect is not detected, the flow returns to Step S12.

Thus, in the data recording routine S31 of the embodiment, the processing for reading the flag information from the memory 33 one time every one rotation of the optical disk 11 is provided in a portion 60 surrounded by dotted lines. It is only necessary to perform the read processing every one rotation of the optical disk 11, so that a load on the system controller 25 can be reduced.

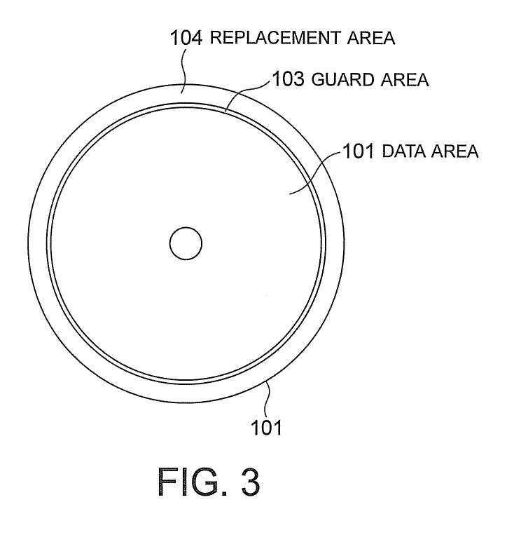

In an optical disk 101 of FIG. 3, a data area 102 and replacement area 104 are provided while a guard area 103 is interposed therebetween. In the case where the are which cannot be read exists in the optical disk 101, the physical address, that is, the address on the optical disk 101 usually modulated into the wobble signal is registered in the defect table of the data area 102, and the write data is written in the replacement area 104.

In the Mt. Rainer standard, when a data recording command is provided during the formatting or verification, the formatting or verifying processing can be interrupted to start the data recording. The processing is realized by the data recording routine shown as Step S31.

The data is recorded according to the defect registration information registered in the formatting processing or verify processing. However, it is also necessary to assume that the data recording command is provided while the formatting processing or verify processing is not ended.

In such cases, the defect is detected in parallel with the recording operation. When the defect is detected during the recording, the recording is interrupted and the defect is immediately registered as the defect. Therefore, the data can be recorded by performing the processing even if the formatting processing or verify processing is not ended.

At this point, when the defect is always monitored like the conventional technique, the large load is applied on the system controller 25.

Not only the defect but also vibration can be cited as the factor that disables the data recording. The recording defect is generated by the vibration in a drive mounted on a notebook (laptop) type personal computer. It is necessary to monitor not only the defect but also the servo state during the recording, and the load on the system controller 25 is further increased.

Therefore, in the embodiment, the flag is read from the memory 33 one time every one rotation of the optical disk 11, thereby reducing the load on the system controller 25. The description will be made below.

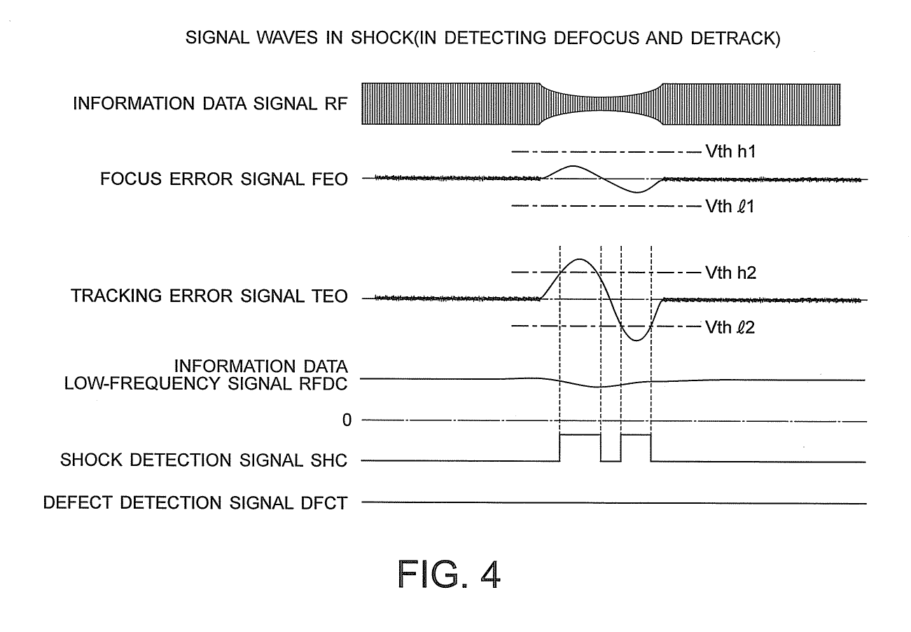

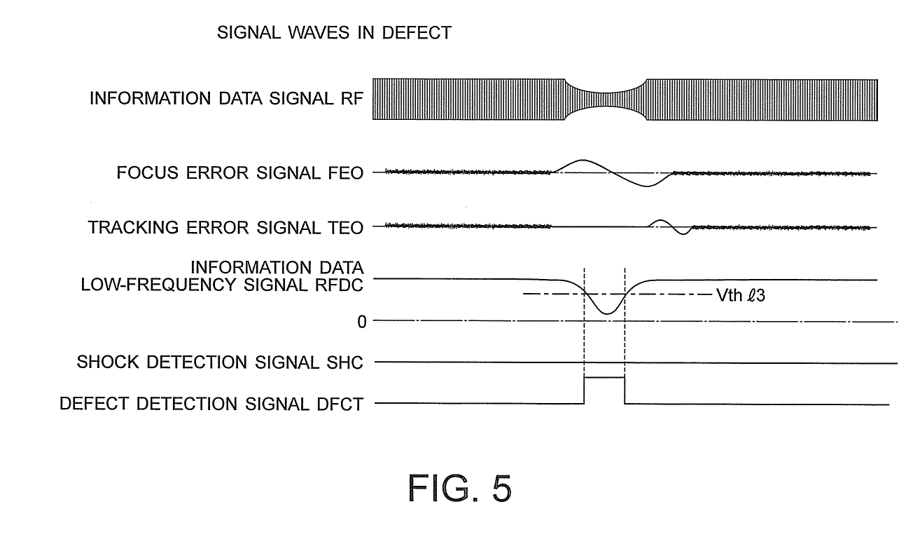

A phenomenon in which the focus error or tracking error is generated during the shock or defect will be described with reference to FIGS. 4 and 5.

An information data low-frequency signal RFDC is one in which a low-frequency component of the information data signal RF is extracted, and the information data low-frequency signal RFDC indicates a surface reflection state of the optical disk 11. A shock signal SHC is a signal of logical addition of a detection flag in which the wobble of the focus error signal FE is sliced in a predetermined slice level (high threshold vthh1 and low threshold Vthl1) and a detection flag in which the wobble of the tracking error signal TE is sliced in a predetermined slice level (high threshold vthh2 and low threshold vthl2). The shock signal SHC indicates the servo operation state. A defect detection signal DFCT is one which a normal level of the information data low-frequency signal RFDC is sliced, and the defect detection signal DFCT indicates existence of the defect.

FIG. 4 shows waveforms of the signals when the servo strays off the trace of the track to detect the detrack due to the vibration from the out side.

The information data signal RF includes the high frequency, and amplitude of the information data signal RF fluctuates small during a period of the shock when the shock is imparted.

A behavior in which a level of the tracking error signal TE fluctuates largely to stray off the trace of the track emerges in FIG. 4. The amplitude of the tracking error signal TE fluctuates more largely to detect the shock, and a resultant pulsed shock signal SHC is supplied.

In the case of the stronger vibration, the focus error signal FE also fluctuates largely to detect the defocus, and sometimes a focal position of a focus lens is shifted.

In such cases, it is necessary to urgently stop the recording, and it is necessary to restart the interrupted recording data.

FIG. 5 shows a change in waveform of each signal when the defect exists. When the defect exists, the light beam is not reflected and a detection light quantity is lowered, thereby lowering a level of the information data low-frequency signal RFDC. Therefore, the defect portion is sliced in a predetermined slice level (low threshold vthl3), which allows the defect detection signal DFCT to be produced.

In such cases, because the data cannot be recorded in the defect area, the area where the defect exists is registered in the defect table of the data area 102, and the data is recorded in the replacement area in the outer circumferential portion of the optical disk 11.

The operation of the memory 33 in the case where the shock is detected and the case where the defect is detected will be described below.

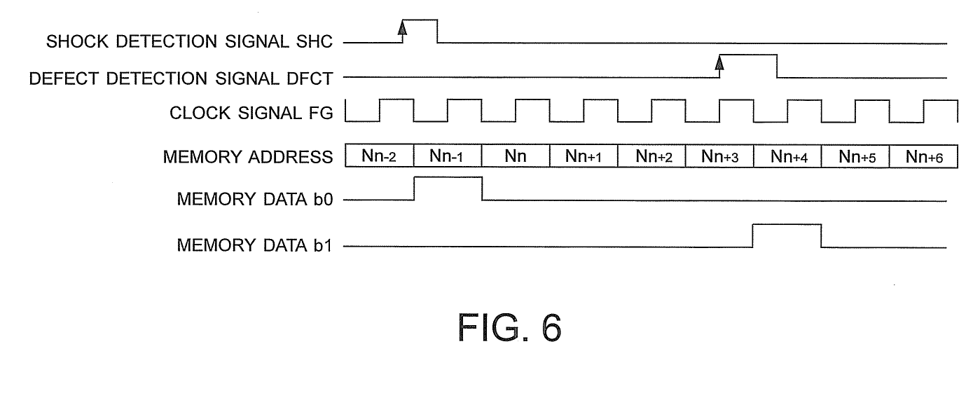

As shown in FIG. 6, a clock signal FG supplied from the disk motor 13 is fed into the write address circuit 34 to produce write addresses “Nn−2, Nn−1, Nn, . . . ” of the memory 33.

On the other hand, the shock signal SHC supplied from the defocus and detrack detection circuit 32 is written in the memory 33 as the flag information in the form of bit data. At this point, the shock signal SHC is written as bit information “bit0” in the memory address “Nn−1”.

The defect detection signal DFCT supplied from the defect detection circuit 31 is written in the memory 33 as the flag information. The defect detection signal DFCT is written as bit information “bit1” in the memory address “Nn+4”. At this point, widths of the pieces of bit information “bit0” and “bit1” correspond to a pulse width of the clock signal FG.

The system controller 25 reads the two types of the flag information written in the memory 33 at one-time interrupt timing per one rotation of the optical disk 11.

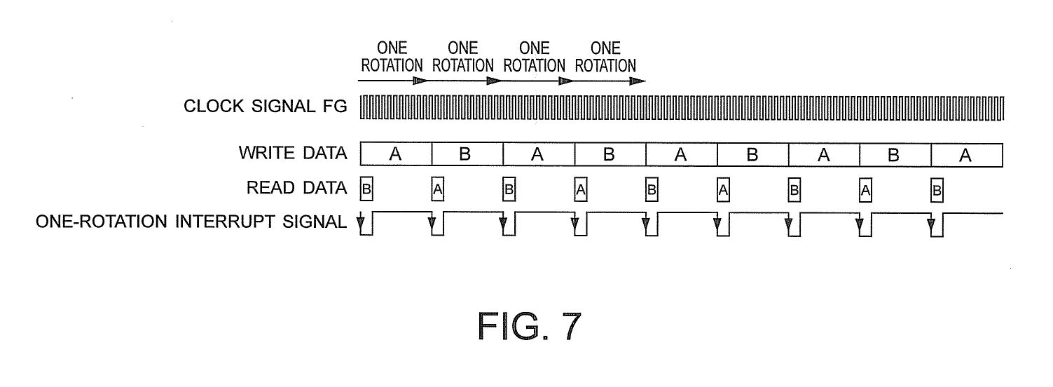

FIG. 7 shows a phenomenon in which the memory bank where the data is written and the memory bank where the data is read are alternately changed every one rotation of the optical disk 11.

The pulsed one-rotation interrupt signal is fed into the system controller 25 every one rotation of the optical disk 11. The data write is performed to the memory bank A in synchronization with one pulse of the clock signal FG while the optical disk 11 is rotated once, and the information read of the memory 33 of one rotation is performed to the memory bank B every one rotation of the optical disk 11.

Because the system controller 25 reads the data from the memory 33 at an extremely high speed, the system controller 25 can instantaneously read the data of one rotation in the burst method. When the one rotation of the optical disk 11 is ended, the data write is performed to the memory bank B and the data read is performed to the memory bank A. Thus, the memory bank where the data is written and the memory bank where the data is read are alternately changed every one rotation of the optical disk 11, so that the operation can be performed as if the write processing and the read processing are concurrently performed.

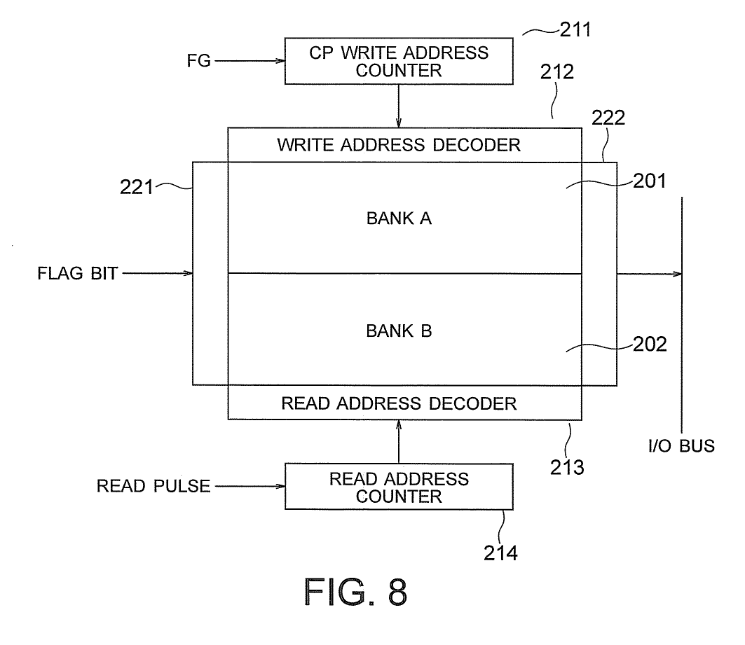

An example of a circuit configuration of the memory 33 will be described with reference to FIG. 8.

The memory 33 includes a memory bank A201, a memory bank B202, a write address counter 211, a write address decoder 212, a read address decoder 213, and a read address counter 214.

The clock signal FG is fed into the write address counter 211, a write address is produced in synchronization with the clock signal FG, and the write address is imparted to the write address decoder 212. For example, the write address decoder 212 specifies the address to the memory bank A, and a flag bit is fed through the data input circuit 221 to perform the write.

On the other hand, a read pulse is imparted to a read address counter 214 to produce a read address, and the read address is imparted to the read address decoder 213. In such cases, the address is specified to the memory bank B, and the read flag is transferred from the I/O bus through the data output circuit 222.

In the optical disk state detection method and apparatus of the embodiment, the load on the system controller can be reduced to simply perform the processing such as the Mt. Rainier recording. Additionally, the defocus information and the detrack information except for the defect of the disk are easily obtained while the load on the system controller is reduced, so that the reliability of the optical disk drive can be improved.

In the present embodiment, the interrupt signal is fed into the system controller 25 every one rotation of the optical disk 11. Therefore, the memory bank where the data is written and the memory bank where the data is read are alternately changed every one rotation of the optical disk 11.

However, a plurality of interrupt signals can be fed into the system controller 25 every one rotation of the optical disk 11. In this case, the memory bank where the data is written and the memory bank where the data is read are alternately changed plural times in every one rotation of the optical disk 11. Further, the system controller 25 reads the defect detection signal n times in a burst method every changing the memory bank where the data is written and the memory bank where the data is read. The n is the number of changing the memory banks alternately in one rotation of the optical disk 11.

The embodiment is described only by way of example, and the invention is not limited to the embodiment. Various modifications and changes can be made without departing from the technical scope of the invention.

What is claimed is:

1. An optical disk state detection apparatus comprising:
a defect detector to which a signal read from an optical disk is imparted, the defect detector detecting a defect to supply a defect detection signal;
rotation synchronous pulse generator supplying a rotation synchronous pulse in synchronization with rotation of the optical disk;
a memory in which the defect detection signal is stored, the defect detection signal being imparted to the memory;
a write circuit which performs write processing of data to the memory;
a read circuit which performs read processing of data from the memory; and
a system controller which controls the read circuit such that the defect detection signal is written in the memory in synchronization with the rotation synchronous pulse and such that the defect detection signal is read at least one time every one rotation of the optical disk from the memory in synchronization with the rotation synchronous pulse.

2. The optical disk state detection apparatus according to claim 1, further comprising an optical pickup which reads data from the optical disk,
wherein the defect detector receives the signal read from the optical pickup, the defect detector detects the defect to supply the defect detection signal, the rotation synchronous pulse generator rotates the optical disk, and the rotation synchronous pulse generator supplies a rotation synchronous pulse in synchronization with the rotation of the optical disk.

3. The optical disk state detection apparatus according to claim 1, wherein the memory includes at least a first bank and a second bank, and
the system controller controls the write circuit and the read circuit such that the read circuit reads data from the second bank in a period during which the write circuit writes data in the first bank and such that the read circuit reads data from the first bank in a period during which the write circuit writes data in the second bank.

4. The optical disk state detection apparatus according to claim 2, wherein the memory includes at least a first bank and a second bank, and
the system controller controls the write circuit and the read circuit such that the read circuit reads data from the second bank in a period during which the write circuit writes data in the first bank and such that the read circuit reads data from the first bank in a period during which the write circuit writes data in the second bank.

5. The optical disk state detection apparatus according to claim 3, wherein the write and the read are alternately performed every one rotation of the optical disk to the first bank, and
the write and the read are alternately performed every one rotation of the optical disk to the second bank.

6. The optical disk state detection apparatus according to claim 3, wherein the write and the read are alternately performed every one rotation of the optical disk to the first bank, and
the write and the read are alternately performed every one rotation of the optical disk to the second bank.

7. The optical disk state detection apparatus according to claim 3, wherein the write and the read are alternately performed plural times every one rotation of the optical disk to the first bank, and
the write and the read are alternately performed plural times every one rotation of the optical disk to the second bank.

8. The optical disk state detection apparatus according to claim 4, wherein the write and the read are alternately performed plural times every one rotation of the optical disk to the first bank, and
the write and the read are alternately performed plural times every one rotation of the optical disk to the second bank.

9. The optical disk state detection apparatus according to claim 1, wherein the defect detector supplies the defect detection signal, when the defect detection signal and a defect of the optical disk are detected in detecting a focus error and a tracking error for the optical disk.

10. The optical disk state detection apparatus according to claim 1, wherein the system controller reads the defect detection signal of one rotation of the optical disk in a burst method every one rotation of the optical disk.

11. The optical disk state detection apparatus according to claim 7, wherein the system controller reads the defect detection signal in a burst method every change between the memory bank for data writing and the memory bank for data reading.

12. A method for detecting an optical disk state in an optical disk apparatus, the optical disk apparatus including rotation synchronous pulse generator, a system controller, a defect detector, a write circuit, a read circuit, and a memory, the method comprising:
detecting a defect from a signal read from an optical disk by the defect detector and supplying a defect detection signal;
controlling the write circuit by the system controller such that the defect detection signal is written in the memory in synchronization with a rotation synchronous pulse, the rotation synchronous pulse being generated from the rotation synchronous pulse generator in synchronization with rotation of the optical disk; and
controlling the read circuit by the system controller such that the defect detection signal written in the memory is read at least one time every one rotation of the optical disk in synchronization with the rotation synchronous pulse.

13. The method for detecting an optical disk state in an optical disk apparatus according to claim 12, wherein the memory includes at least a first bank and a second bank, and
the system controller controls the write circuit and the read circuit such that the read circuit reads data from the second bank in a period during which the write circuit writes data in the first bank and such that the read circuit reads data from the first bank in a period during which the write circuit writes data in the second bank.

14. The method for detecting an optical disk state in an optical disk apparatus according to claim 12, wherein the write and the read are alternately performed every one rotation of the optical disk to the first bank, and
the write and the read are alternately performed every one rotation of the optical disk to the second bank.

15. The method for detecting an optical disk state in an optical disk apparatus according to claim 13, wherein the write and the read are alternately performed every one rotation of the optical disk to the first bank, and
the write and the read are alternately performed every one rotation of the optical disk to the second bank.

16. The method for detecting an optical disk state in an optical disk apparatus according to claim 12, wherein the write and the read are alternately performed plural times every one rotation of the optical disk to the first bank, and
the write and the read are alternately performed plural times every one rotation of the optical disk to the second bank.

17. The method for detecting an optical disk state in an optical disk apparatus according to claim 13, wherein the write and the read are alternately performed plural times every one rotation of the optical disk to the first bank, and
the write and the read are alternately performed plural times every one rotation of the optical disk to the second bank.

18. The method for detecting an optical disk state in an optical disk apparatus according to claim 12, wherein the defect detector supplies the defect detection signal, when the defect detection signal and a defect of the optical disk are detected in detecting a focus error and a tracking error for the optical disk.

19. The method for detecting an optical disk state in an optical disk apparatus according to claim 12, wherein the system controller reads the defect detection signal of one rotation of the optical disk in a burst method every one rotation of the optical disk.

20. The method for detecting an optical disk state in an optical disk apparatus according to claim 16, wherein the system controller reads the defect detection signal in a burst method every change between the memory bank for data writing and the memory bank for data reading.
